(19) United States
(12) Patent Application Publication
(10) Pub. No.: US 2014/0231327 A1
(43) Pub. Date: Aug. 21, 2014

(54) PORTABLE SOLAR APPARATUS FOR PURIFYING WATER

(71) Applicant: Research Foundation of the City University of New York, New York, NY (US)

(72) Inventors: Joseph James D'Alba, Ormond Beach, FL (US); George Victor St. Pierre, Ormond Beach, FL (US); Ali M. Sadegh, Franklin Lakes, NJ (US); Jorge E. Gonzalez, Baldwin, NY (US)

(73) Assignees: Research Foundation of the City University of New York, New York, NY (US); Sun Fresh Water, LLC, Ormond Beach, FL (US)

(21) Appl. No.: 14/169,765

(22) Filed: Jan. 31, 2014

Related U.S. Application Data
(60) Provisional application No. 61/850,378, filed on Feb. 15, 2013.

(51) Int. Cl. B01D 3/00; C02F 1/14

(52) U.S. Cl. CPC B01D 3/00; C02F 1/14
USPC 210/175

(57) ABSTRACT

A production unit for purifying water is provided. The production unit has a fluid intake and a heating basin fluidly connected to the fluid intake by a connector such that a layer of water with a depth of less than about 30 mm is provided. A transparent dome is mounted to the top surface of the base that defines an interior perimeter. A trough in the base is contiguous with an interior surface of the transparent dome. A fluid output is fluidly connected to the trough and extends away from the base. A plurality of lenses is configured to focus sunlight onto a corresponding plurality of focal points located on the layer of water.

### CROSS-REFERENCE TO RELATED APPLICATIONS

This application is a non-provisional of U.S. Ser. No. 61/850,378 (filed Feb. 15, 2013). The content of the aforementioned patent application is hereby incorporated by reference in its entirety.

### BACKGROUND OF THE INVENTION

The subject matter disclosed herein relates to systems for purifying water using solar power. As developing countries continue to expand, the governments struggle to provide an adequate water and power infrastructure. In rural areas, this is particularly difficult. Often, water that is contaminated with salts or microorganisms is consumed as the availability of pure drinking water is limited.

Previous attempts have been made to desalt or otherwise purify water have been made, but none have proven entirely satisfactory. Such attempts are often too costly for use in developing countries or have an insufficient throughput for practical applications. A improved method for purifying water is therefore desired.

The discussion above is merely provided for general background information and is not intended to be used as an aid in determining the scope of the claimed subject matter.

### BRIEF DESCRIPTION OF THE INVENTION

Disclosed in this specification is a production unit for purifying water using solar power. An advantage that may be realized in the practice of some disclosed embodiments of the system is the production if a larger throughput of purified water compared to other solar-powered water purifications systems. Another advantage is the inexpensive nature of the system.

In one embodiment, a production unit for purifying water is provided. The production unit comprises a fluid intake and a heating basin fluidly connected to the fluid intake by a connector such that a layer of water with a first depth is provided, the first depth being less than about 30 mm. A transparent dome is mounted to the top surface of the base that defines an interior perimeter. A trough in the base is contiguous with an interior surface of the transparent dome. A fluid output is fluidly connected to the trough and extends away from the base. A plurality of lenses is configured to focus sunlight onto a corresponding plurality of focal points located on the layer of water.

This brief description of the invention is intended only to provide a summary of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a perspective view of a system for purifying water;

FIG. 2 is a cross-section view of the production unit of FIG. 1;

FIG. 3 is a detailed view of select components of the production unit of FIG. 1;

FIG. 4A is a cross-section view of an exemplary production unit showing the orientation of the plurality of lenses while FIG. 4B is a top view of the embodiment of FIG. 4A showing a total of five lenses;

FIG. 5 depicts a second exemplary embodiment of another production unit; and

FIG. 6 is a schematic illustration of a reflective material configured to reflect sunlight into the transparent dome.

### DETAILED DESCRIPTION OF THE INVENTION

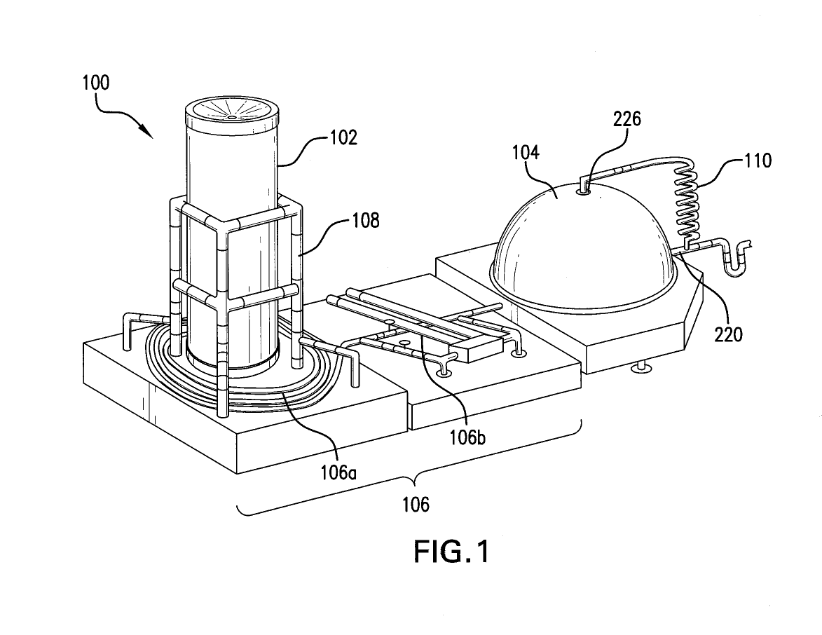

FIG. 1 is a perspective view of a system 100 for purifying water. The system 100 comprises a reservoir 102 for holding water, a production unit 104 for distilling water using solar power, and a pre-heating system 106 that is fluidly connects the reservoir 102 to the production unit 104. In one embodiment, the pre-heating system 106 comprises a black tube 106a. In another embodiment, the pre-heating system 106 comprises an evacuated tube 106b. In the exemplary embodiment of FIG. 1, the pre-heating system 106 comprises both the black tube 106a and the evacuated tube 106b. The pre-heating system 106 warms water from the reservoir 102 to an elevated temperature (e.g. 70° C. to 90° C.) and supplies the warmed water to the production unit 104.

Each of the reservoir 102, the production unit 106 and the pre-heating system 106 may be provided as a separate module, thereby permitting the user to use multiple modules (e.g. several evacuated tubes 106b) or omit a module, as the user desires. In some embodiments, the reservoir 102 is supported by a framework 108 that provides structural support for the reservoir 102. In one embodiment, the reservoir 102 is connected to a rainwater collection system to directly capture rainwater for future purification.

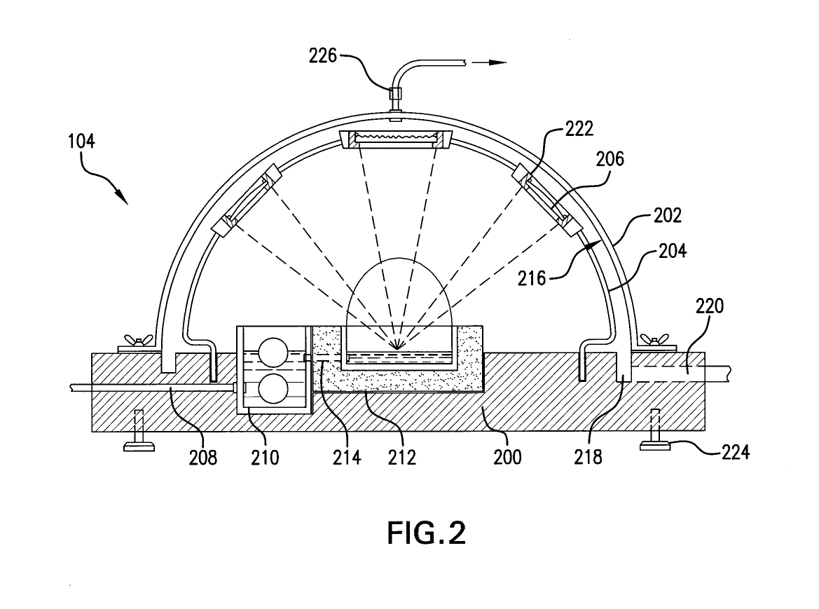

FIG. 2 is a cross-section view of the production unit 104. The production unit 104 comprises a base 200, a transparent dome 202, a network of frames 204 that supports a plurality of lenses 206. The network of frames 204 may be formed, for example, from metal or plastic materials. The base 200 may be equipped with leveling screws 224, each of which can be manually adjusted to level the base. In one embodiment, a rainwater collection system collects rainwater from an outside surface of the transparent dome 202 and directions the rainwater to the reservoir 102.

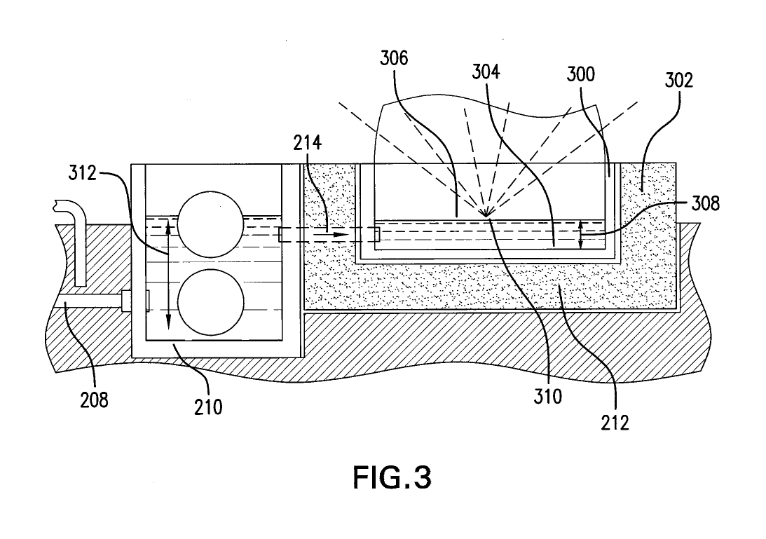

In use, the pre-heating system 106 (see FIG. 1) delivers water into the production unit 104 by way of a fluid intake 208. In the exemplary embodiment of FIG. 1, the water is first delivered to a float basin 210. As the water accumulates within the float basin 210, the water eventually flows into a heating basin 212 by way of a connector 214. As shown in detail in FIG. 3, the connector 214 is positioned to produce a thin layer of water in the heating basin 212. As purified water condenses on an interior surface 216 of the transparent dome 202 and flows into a trough 218 in the base 200. The trough 218 is contiguous with the interior surface to facilitate capture of the purified water. The production 104 also comprises a fluid output 220 that is in fluid communication with the trough 218. A water collection container (not shown) may be fluidly attached to the fluid output 220 for receiving the purified water.

The transparent dome 202 permits solar thermal energy to penetrate the transparent dome 202. In one embodiment, the transparent dome 202 is formed from a optically transparent acrylic material. In one embodiment, the interior surface 216 of the transparent dome 202 is surface-treated to increase the hydrophobic character of the interior surface 216. Exemplary surface treatments include micron layer of zinc surfaces treated by chemical bath deposition. In one embodiment, the transparent dome 202 is circular. In another embodiment, the transparent dome 202 is oval-shaped. In yet another embodiment, the transparent dome 202 has the shape of an ellipse. The transparent dome 202 may have a diameter that is sufficiently small to permit the device to be transported by a human being. For example, the transparent dome 202 may have a diameter of about 46 cm.

The plurality of lenses 206 may include convex lenses and/or Fresnel lenses. In one embodiment, one or more lens of the plurality of lenses 206 has a self-adjusting motor 222 connected thereto. The self-adjusting motor 222 is solar powered and is configured to re-position each lens to maintain the focal point 310 (see FIG. 3) as sunlight direction changes over time.

In certain embodiments, the transparent dome 202 may comprise a top output 226. The top output 226 receives water vapor from the transparent dome 202. The top output 226 is fluidly connected to the water collection container. Referring to FIG. 1, the top output 226 has a coiled condenser 110. In the exemplary embodiment of FIG. 1, the top output 226 is fluidly connected to the water collection container by being united with fluid output 220.

FIG. 3 is a detailed view of select components of the production unit 104. In the exemplary embodiment of FIG. 3, the heating basin 212 comprises a dish 300 disposed within a firebrick 302. In one embodiment, the dish 300 is a ceramic dish. The connector 214 is positioned proximate to a bottom 304 of the dish 300 such that a layer of water 306 with a minimal first depth 308 is produced. In yet another embodiment a planar sponge (or metal foam) are placed on top of the dish 300 to increase and enhance the water surface area for better evaporation. The plurality of lenses 206 (see FIG. 2) are configured to focus sunlight onto a corresponding plurality of focal points 310 located on the layer of water 306. Collectively, the corresponding plurality of focal points 310 provide an area that is subject to heating. In one embodiment, the layer of water 306 is within a sponge. The first depth 308 is controlled to promote evaporation of water. In one embodiment the first depth 308 is greater than zero and less than 30 mm. In another embodiment, the first depth 308 is greater than zero and less than 20 mm. In yet another embodiment, the first depth 308 is greater than zero and less than 10 mm. The outside of the transparent dome 202 may comprise a solar powered fan to promote cooling of the transparent dome 202 and facilitate condensation of water vapor.

The bottom 304 of the dish 300 may also have a roughened and reflective surface to further promote evaporation. In one embodiment, the bottom 304 has an average surface roughness of between about 10 microns and 100 microns. In another embodiment, the average surface roughness is between about 100 mm and 500 mm microns. In yet another embodiment, the average surface roughness is between about 0.5 mm and 2 mm. In the float basin 210, the connector 214 is disposed above the fluid intake 208 to maintain water at a level equal to or less than a second depth 312. The float basin 210 may include a floating valve to control actuation of connector 214. Such a configuration promotes a consistent depth of the layer of water 306.

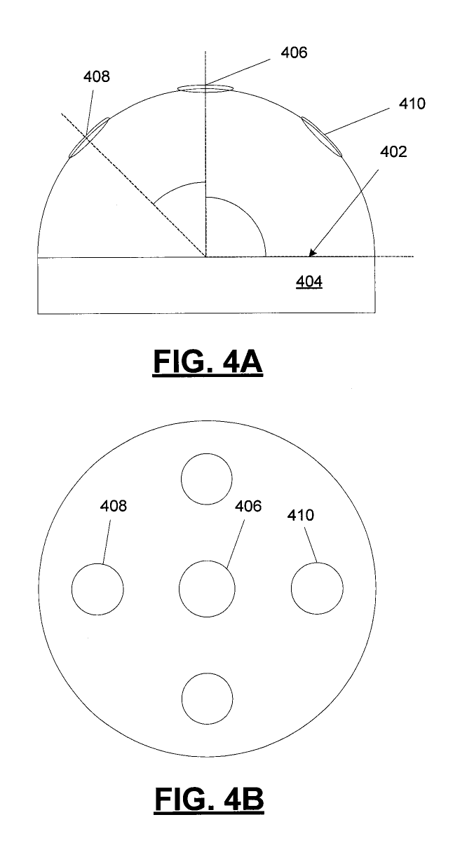

FIG. 4A is a cross-section view of an exemplary production unit showing the orientation of the plurality of lenses. Each lens in the plurality of lenses is disposed at about a 90° angle or about a 45° angle relative to the top surface 402 of the base 404. For example, lens 406 is disposed at about a 90° angle relative to the top surface 402. Lenses 408, 410 are disposed at about a 45° angle relative to the top surface 402. In the cross-section view of FIG. 4A, only three lenses are visible. FIG. 4B is a top view of the embodiment of FIG. 4A showing a total of five lenses. In other embodiments, additional lenses, or fewer lenses, are present.

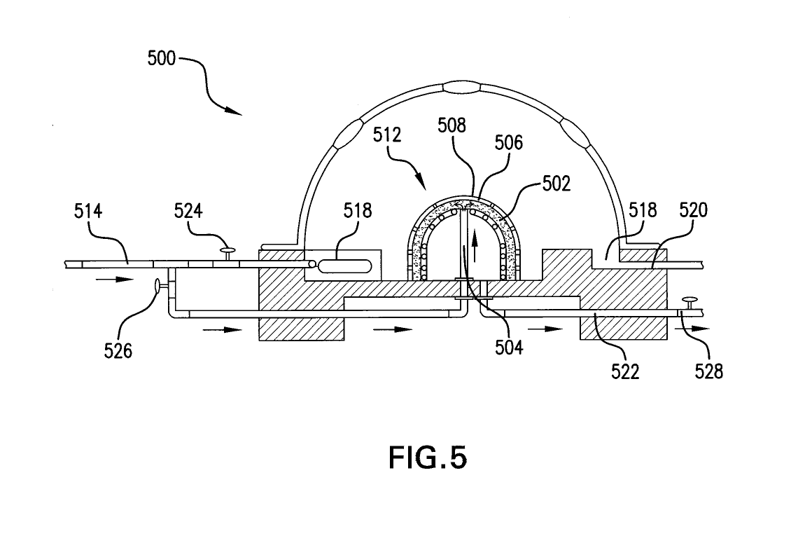

FIG. 5 depicts a second exemplary embodiment of a production unit 500. The production unit 500 is similar to the production unit 104 except in that a heating basin 512 has a different configuration. The heating basin 512 comprises a sponge 502 that is contiguous with a connector 504 such that the layer of water 506 is formed by a wicking action of the sponge 502. The depth of the layer of water 506 is determined by the thickness of the sponge 502. In one embodiment, a metal mesh 508 is located at the focal points of the plurality of lenses. The metal mesh serves to transfer heat to the sponge and thereby promote evaporation. The sponge is confined between the metal mesh, and a dome-shaped structure. The dome-shaped structure may be formed of, for example, metal or ceramic. Such a configuration retains heat near the sponge and holds the sponge in the shape of a dome.

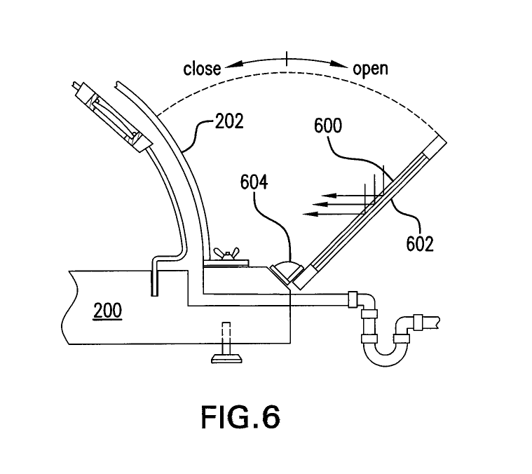

FIG. 6 is a schematic illustration of a reflective material 600 disposed outside of the transparent dome 202 configured to reflect sunlight into the transparent dome 202 and thereby increase ambient temperature within the transparent dome 202. The reflective material 600 may be a mirror, a reflective metal, or the like. The reflective material 600 is attached to a support 602 which connects to the base 200 by a hinge 604. The user manually actuates the hinge 604 so as to reflect heat into the transparent dome 202. In another embodiment, the orientation of the reflective material 600 is controlled by one or more self-adjusting motors which are solar powered.

In one embodiment, multiple systems 100 are utilized in a nested configuration to deliver water to a single water collection container. Each system has been shown to generate about 20 liters per square meter of the transparent dome. This throughput is a significant improvement (approximately fivefold higher) over conventional solar-powered water purification systems. The system disclosed in this specification is useful for purifying water of a variety of contaminates and finds particular utility in desalinating salt water or brackish water.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Referring to FIG. 5, a flushing system could be utilized to periodically clean residues of water contamination from the sponge or the ceramic can be removed and cleaned. The flushing system comprises input piping 514 that introduces water to trough 518 and/or to sponge 502 based on the operation of control valves 524 and/or 526 in input piping 514. This water exits through fluid output 520 and/or exit piping 522 and carries residues with it. Water flow through exit piping 522 may be controlled by operation of control valve 528.

What is claimed is:

1. A production unit for purifying water, the production unit comprising:
a base with a top surface;
a fluid intake;
a heating basin fluidly connected to the fluid intake by a connector such that a layer of water with a first depth is provided to the heating basin from the fluid intake, the first depth being less than about 30 mm;
a transparent dome mounted to the top surface of the base that defines an interior perimeter, the transparent dome having an interior surface;
a trough in the base, the trough being contiguous with the interior surface of the transparent dome;
a fluid output fluidly connected to the trough and extending away from the base;
a plurality of lenses configured to focus sunlight onto a corresponding plurality of focal points located on the layer of water.

2. The production unit as recited in claim 1, wherein the heating basin comprises a sponge that is contiguous with the connector such that the layer of water is formed by a wicking action of the sponge.

3. The production unit as recited in claim 2, further comprising a metal mesh at the corresponding plurality of focal points, the metal mesh configured to transfer heat to the sponge.

4. The production unit as recited in claim 1, further comprising a float basin fluidly connected to the fluid intake, the float basin being disposed within the base and configured to hold a second depth of water, the connector of the heating basin being disposed above the fluid intake.

5. The production unit as recited in claim 4, wherein the heating basin comprises a dish disposed in the base and the connector is disposed proximate a bottom of the dish.

6. The production unit as recited in claim 5, wherein the bottom of the dish has a surface roughness of at least 10 microns.

7. The production unit as recited in claim 1, further comprising a water collection container fluidly connected to the fluid output for receiving purified water.

8. The production unit as recited in claim 7, further comprising a top output disposed at a top portion of the transparent dome, the top output being fluidly connected to the water collection container.

9. The production unit as recited in claim 8, the top output further comprising a coiled condenser.

10. The production unit as recited in claim 1, further comprising a self-adjusting motor connected to each lens in the plurality of lenses, the self-adjusting motor configured to re-position each lens to maintain the focal point of each lens as sunlight changes over time.

11. The production unit as recited in claim 1, wherein the plurality of lenses are disposed within the transparent dome and are supported by a network of frames.

12. The production unit as recited in claim 1, wherein the transparent dome is circular.

13. The production unit as recited in claim 1, wherein each lens in the plurality of lenses is disposed at about 90° or about 45° relative to the top surface of the base.

14. The production unit as recited in claim 1, further comprising a reflective material disposed outside of the transparent dome configured to reflect sunlight into the transparent dome and thereby increase ambient temperature within the transparent dome.

15. A system for purifying water, the system comprising:
a reservoir;
a production unit production unit comprising:
a base with a top surface;
a fluid intake;
a heating basin fluidly connected to the fluid intake by a connector such that a layer of water with a first depth is provided to the heating basin from the fluid intake, the first depth being less than about 30 mm;
a transparent dome mounted to the top surface of the base that defines an interior perimeter, the transparent dome having an interior surface;
a trough in the base, the trough being contiguous with the interior surface of the transparent dome;
a fluid output fluidly connected to the trough and extending away from the base;
a plurality of lenses configured to focus sunlight onto a corresponding plurality of focal points located on the layer of water;
a pre-heating system fluidly connecting the reservoir to the production unit, the pre-heating system comprising a heating element selected from the group consisting of a black tube, an evacuated tube, and combinations thereof.
